(19) United States
(12) Patent Application Publication
(10) Pub. No.: US 2017/0183105 A1
(43) Pub. Date: Jun. 29, 2017

(54) DISPLAY OF METEOROLOGICAL DATA IN AIRCRAFT

(71) Applicant: THALES, COURBEVOIE (FR)

(72) Inventors: François FOURNIER, TOULOUSE (FR); Frédéric PANCHOUT, TOULOUSE (FR); Mathieu CORNILLON, TOULOUSE (FR); Christophe LERAT, TOULOUSE (FR)

(21) Appl. No.: 15/389,227

(22) Filed: Dec. 22, 2016

(30) Foreign Application Priority Data
Dec. 29, 2015 (FR) 1502714

(51) Int. Cl. B64D 45/00; G09G 5/37; G06T 11/60; G08G 5/00; G01C 21/00

(52) U.S. Cl. CPC B64D 45/00; G08G 5/0039; G01C 21/00; G06T 11/60; G09G 5/37; B64D 2045/0075; G09G 2380/12; G09G 2370/04; G09G 2320/10

(57) ABSTRACT

A method implemented by a computer for managing meteorological data for the management of the flight of an aircraft, comprises the steps of receiving a cartographic background and meteorological data associated with the flight plan, selecting one or more meteorological events; displaying graphic representations associated with the meteorological events selected on a strip representing the flight plan; based on the updating of the meteorological data, refreshing the display of the meteorological data. Developments notably describe the re-refreshing of the display corresponding to a revision of the flight plan, taking into account of the severity of the meteorological events, the emission of alerts and/or selectable notifications, the distinction between meteorology of regulatory type and of non-regulatory type. Software and system aspects are described (e.g. electronic flight bag EFB).

### CROSS-REFERENCE TO RELATED APPLICATIONS

This application claims priority to foreign French patent application No. FR 1502714, filed on Dec. 29, 2015, the disclosure of which is incorporated by reference in its entirety.

### FIELD OF THE INVENTION

The invention relates to the technical field of meteorological data management in the context of navigation assistance for a transport means such as an aircraft.

### BACKGROUND

Meteorological information is essential for assisting in the navigation of an aircraft, which moves rapidly in varied and changing atmospheric conditions.

The meteorological conditions influence the operational mission preparation and in-flight decisions. The decisive meteorological events notably comprise atmospheric movements (e.g. wind, storm, convection, turbulences, etc.), hydrometeorological formations (e.g. rain, snow, fog, etc.), ice, low or reduced visibility conditions, electrical phenomena (lightning).

The meteorological data are supplied in text and/or graphic form. With regard to the meteorological data of graphic type, they are generally displayed in the form of symbols, which are superimposed on one or more cartographic backgrounds or overlays.

Different display options are generally offered to the pilot to navigate efficiently within the meteorological data. These options notably comprise the possibility of selecting or filtering one or more criteria associated with a particular type of meteorological event, the possibility of selecting or of manipulating the display overlays, of choosing or of benefitting from the use of colour codes in order to indicate any risks or priorities, of managing the transparency of the different symbols displayed on the screen, etc.

Even so, these approaches present limitations.

The current display options present limitations. In particular, the display of all the meteorological data does not make it possible to easily take decisions. The pilot has to make a mental effort and/or carry out numerous and laborious manual operations to identify a meteorological information item that is useful to the flight plan, notably to determine whether this meteorological information is critical to it or not. The tools for navigating in the data which are currently accessible to the pilot often require numerous procedures.

Furthermore, the pilot is often confronted with flight plan modifications from his or her planned initial flight plan, whether these modifications are made by the FMS, or else manually by the pilot on an EFB or an FMS, or else proposed by the airline operations centre, or else required by air traffic control. The pilot must then systematically re-analyse the weather situation along his or her new route, which represents a massive task occupying a great part of his or her cognitive load.

There is an operational need for advanced systems and methods for managing meteorological data within the cockpits of aircraft.

### SUMMARY OF THE INVENTION

A method is disclosed that is implemented by a computer for managing meteorological data for managing the flight of an aircraft, comprising the steps consisting in receiving a cartographic background and meteorological data associated with the flight plan; selecting one or more meteorological events, displaying graphic representations of the meteorological events on a strip representing the flight plan of the aircraft; based on the updating of the meteorological data, refreshing the display of the meteorological data selected and associated with the flight plan of the aircraft. Developments notably describe the refreshing of the display corresponding to a revision of the flight plan, the taking into account of the severity of the meteorological events, the emission of alerts and/or of selectable notifications, the distinction between meteorology of regulatory type and of non-regulatory type. Software and system aspects are described (e.g. electronic flight bag EFB).

The invention consists in producing and displaying the summary of the meteorological events along the route of the aeroplane.

Advantageously, the embodiments of the invention make it possible to provide the pilot with a summary of the meteorological phenomena that the aircraft will encounter along its route. The information provided is contextual and relevant for the flight plan, the summary being produced by a correlation using intersections between the available meteorological data and the planned flight plan and/or the trajectory actually flown, on the four space and time dimensions, by projection of the position of the aircraft into the future.

Advantageously, the examples described simplify the human-machine interactions and in particular relieve the pilot of tedious procedures for accessing the meteorological information. Sometimes repetitive and often complex, by the same token improving his or her concentration capacity for the actual piloting. Consequently, the cognitive load of the pilot dedicated to meteorological management is reduced. Improving the human-machine interaction model, the visual field of the pilot can be used best and more intensively, making it possible to maintain a high level of attention or best make use thereof. The cognitive effort to be provided is optimized, or, to be more precise, partially reallocated to cognitive tasks that are more useful with regard to the piloting objective. The pilot can concentrate on other piloting tasks. The aircraft flight safety is increased.

Advantageously according to the invention, the meteorological information is updated. More specifically, “informative” meteorological information is added to the “regulatory” meteorological information (concepts described hereinbelow). The latter remains accessible at all times and at the request of the pilot.

Advantageously according to the invention, the updated meteorological information is in addition correlated with the current flight plan of the aircraft. In other words, the method according to the invention sets the intersection of the meteorological events that are relevant for the current flight plan. Whatever the revision (or modification) to the flight plan, the display of the weather events is refreshed.

Advantageously, the method according to the invention allows the pilot to anticipate the future situation of the aircraft from the meteorology point of view. In one embodiment, the meteorological data beyond 200 nautical miles (˜30 min) are displayed (beyond the current capabilities of its embedded sensors), to assist the pilot in his or her long term strategic navigation decision-making.

Advantageously, in an embodiment of the invention upon an updating of the data and/or upon a synchronization of the data and/or updating or modification of the flight plan, the pilot—not consulting the weather information at the time of the update and/or synchronization and/or modification—will be notified subsequently (for example visually) of corresponding data modifications to the flight plan concerned.

### BRIEF DESCRIPTION OF THE DRAWINGS

Other features and advantages of the invention will become apparent from the following description and from the attached drawings in which:

FIG. 1 illustrates the overall technical environment of the invention;

FIG. 2 schematically illustrates the structure and the functions of a flight management system of known FMS type;

FIG. 3 shows an exemplary human-machine interface according to the invention for displaying information of meteorological nature;

FIG. 4 illustrates examples of interaction of the pilot with the human-machine interface according to the invention;

FIG. 5 shows examples of steps of the method according to the invention;

FIG. 6 illustrates variant embodiments of the human-machine interface according to the invention.

### DETAILED DESCRIPTION

The invention generalizes the concept of meteorological (“weather”) data.

In avionics world, the meteorological data can be classified in a number of categories (e.g. the so-called “regulatory” or “normative” meteorology, the so-called “informative” or “strategic” meteorology, the “radar” meteorology, measured by embedded apparatuses).

Regarding the so-called regulatory meteorology, the meteorological observations and forecasts are incorporated in a regulatory meteorological file called “briefing” which is supplied to the pilot before the take-off of the aeroplane. This regulatory meteorology is limited. The form and the format is basic (text code and graphics in black and white) and the data are generally valid only for a restricted time interval (of the order of 3 to 6 hours). This inevitable obsolescence of the meteorological data leads to significant complications and notably some risks to the safety of the flight.

Regarding the so-called “informative” or “forecast” or “strategic” meteorology, the data of this type are generally presented in the form of graphic data. They have the particular feature of complementing the regulatory data necessary to the operation of the flight. The aim of the forecast or informative meteorology is to give advisory information at a strategic level, at the point where the weather radar has insufficient range and where the “briefing” information is no longer up to date. The updating of this type of meteorological data is currently limited in the existing systems. For example, the use of ACARS with AOC provides updates which are only textual. Consequently, the pilots have additional information, but information that is poor in content and/or of limited validity. At the cost of tedious procedures, the pilots have to seek, find, extract and interpret the relevant information in this limited information.

Regarding the radar meteorology, its range is limited by the measurement apparatuses (i.e. short range). It is used directly for the piloting.

Even more generally, defined according to the invention, the meteorological data can be segmented (with overlap) or partitioned (with overlap) according to different “quality” or “service” levels. According to the invention, third-party (to the regulatory meteorology) data sources can be taken into account in the meteorological summary of the method according to the invention. For example, a data source indicating the presence of migratory birds in a given sector can help to improve the “meteorological” understanding in the broad sense. A certain quantity of data, of strategic and informative type, different from the regulatory data from the flight dossier, can be refreshed and consulted in flight, originating from sensors internal to the aircraft or accessible by downloading from the ground via communication means (satellite or similar). In one embodiment, one or more data of non-regulatory type can be requalified as data of a level equivalent to that of the regulatory data (see below).

The invention can notably be implemented on one or more electronic flight bags EFB and/or on one or more flight management systems FMS and/or on one or more screens of the cockpit display system CDS. The display can be “distributed” over these different display screens.

An electronic flight bag, acronym EFB, designates embedded electronic libraries. An EFB is an electronic device used by the navigating personnel (for example pilots, maintenance, cabin crew, etc.). An EFB can supply flight information to the crew, assisting the latter in performing tasks (with increasingly less paper). One or more applications make it possible to manage information for flight management tasks. These general-purpose computer platforms are intended to reduce or replace the reference material in paper form, often found in the hand baggage of the “Pilot Flight Bag” and the handling of which can be tedious, notably in critical flight phases. The reference paper documentation generally comprises the piloting manuals, the various navigation maps and the ground operation manuals. These documentations are advantageously dematerialized in an EFB. Furthermore, an EFB can host software applications specially designed to automate the operations carried out manually in normal time, such as, for example, the take-off performance computations (computation of limit velocities, etc.). There are different classes of EFB hardware. The removable EFBs are portable electronic devices (PED), which are not normally used during take-off and other critical phases. This class of device does not require any particular certification or authorization administrative process. The so-called installed EFB devices are normally arranged in the cockpit, e.g. mounted in a position where they are used during all the flight phases. This class of devices requires prior authorization for use. The removable and installed devices are considered as portable electronic devices. Fixed avionics installations, such as computer mounts or fixed docking stations installed in the cockpit of the aircraft generally require the approval of and certification from the regulator.

Like any display device, the quantity of information to be displayed on an EFB can come up against limits (notably with regard to the display of weather data) and it is advantageous to implement methods optimizing the display of data.

In addition, or as an alternative, to the display on one or more EFBs, data can be displayed on one or more screens of the FMS displayed in the cockpit of the aircraft. The acronym FMS corresponds to “Flight Management System” and designates the aircraft flight management systems. In the preparation for a flight or upon a diversion, the crew proceeds to input different information relating to the progress of the flight, typically by using an aircraft flight management system FMS. An FMS comprises input means and display means, as well as computation means. An operator, for example the pilot or the co-pilot, can input, via the input means, information such as RTA (Required Time of Arrival), associated with waypoints, that is to say points vertical or through which the aircraft must pass. These elements are known in the prior art through the international standard ARINC 424. The computation means notably make it possible to compute, from the flight plan comprising the list of waypoints, the trajectory of the aircraft, as a function of the geometry between the waypoints and/or of the altitude and velocity conditions.

Hereinafter in the document, the acronym FMD is used to denote the display of the FMS present in the cockpit, generally arranged head-down (at the lower level of the instrument panel).

The acronym ND is used to denote the graphic display of the FMS present in the cockpit, generally arranged head mean, i.e. in front of the face. This display is defined by a reference point (centred or at the bottom of the display) and a range, defining the size of the display area.

The acronym HMI corresponds to the human-machine interface. The input of the information, and the display of the information input or computed by the display means, constitute such a human-machine interface. Generally, the HMI means make it possible to input and consult the flight plan information. The embodiments described hereinbelow detail advanced HMI systems.

Different embodiments of the invention are described hereinbelow.

A method is disclosed that is implemented by a computer for managing meteorological data for managing the flight of an aircraft, comprising the steps consisting in receiving a cartographic background out of several predefined cartographic backgrounds; receiving meteorological data associated with the flight plan of the aircraft; selecting one or more meteorological events out of said meteorological data; displaying one or more graphic representations associated with the selected meteorological events on a horizontal or vertical strip representing the flight plan of the aircraft; and, based on the updating of the meteorological data, refreshing the display of the meteorological data selected and associated with the flight plan of the aircraft.

The verb “refresh” means “update”.

In a development, the method further comprises a step consisting in receiving a revision of the flight plan of the aircraft and a step consisting of re-updating the steps of selection and of the display of the meteorological events selected.

In one embodiment of the invention, the flight plan conditions (unilaterally) the filter and the display of the meteorological events. In other words, the flight plan (which can change) serves as a reference for determining the meteorological events that are relevant in light of predefined criteria. A dangerous cumulonimbus placed on the route of the aircraft will be indicated to the pilot. This is an essentially tactical embodiment.

In a development, the step consisting in refreshing the display of the meteorological data comprises one or more steps chosen from the steps comprising a step consisting in adding the graphic representation of a meteorological event, a step consisting in deleting the graphic representation of a meteorological event and a step consisting in modifying the graphic representation of a meteorological event.

In a development, the graphic representation of a meteorological event is a descriptive display area, of which at least a part of the graphic form and/or of the colour and/or of the texture is determined as a function of the degree of severity of the associated meteorological event.

In a development, the graphic representations of the meteorological events are arranged according to predefined display priorities.

The display priorities or rules can notably provide a display by descending order of severity along the flight plan of the aircraft.

In a development, at least one meteorological event is associated with a one-off time of occurrence and/or a validity time interval.

In a development, the method further comprises the step consisting in displaying the time delay before the next expected update of the meteorological data.

In a development, the method further comprises a step consisting in determining a modification or a revision of the flight plan or a flight setpoint as a function of at least one modification of the meteorological data and a step consisting in displaying said modification or revision or setpoint to the pilot.

In one embodiment, computations in the background assess the need to adapt the flight plan as a function of the meteorology.

In one embodiment, the flight plan data and the meteorological data influence one another (bilateral interaction).

In particular, by multiplying the virtual or possible flight plans at a given instant and by determining the selection of meteorological events for each virtual flight plan, it is possible to assist the pilot in his or her navigation by enabling him or her to compare different alternative flight plans from the point of view of the meteorological obstacles. In one embodiment, the pilot can compare the meteorological summaries of each possible route or of several routes of his or her choice. The comparisons between flight plans can be made in different ways. In one embodiment, the meteorological summaries are compared graphically (e.g. side-by-side, by superimposition and by use of colours, etc.). In one embodiment, each meteorological event can be associated with a score; the comparison step then manipulates the summation of the scores for the plurality of routes compared. An optional optimization step can consist in minimizing the sum of the scores. This type of embodiment is essentially strategic.

In a development, the method further comprises a step consisting in determining the modification of the flight plan of the aircraft necessary to fly around a meteorological event determined as severe and a step consisting in displaying an alert if said modification of the flight plan exceeds a predefined threshold.

In a development, the method further comprises a step consisting in determining the existence of a meteorological event associated with a severity level in excess of a predefined threshold and a step consisting in graphically displaying a selectable visual notification indicating the existence of said meteorological event.

In a development, the meteorological data are meteorological data of nonregulatory type.

The meteorological data are partitioned (without overlap) between data of regulatory type and meteorological data of non-regulatory type.

In one embodiment, the meteorological data of non-regulatory type are associated with a plurality of levels or sources of quality or of reliability.

In a decision-making system, the quality of the data refers to a set of requirements (e.g. in terms of accuracy, of veracity, of variety, of depth, of freshness, etc.). In avionics, the sources or the origins of the data will be able to be considered (levels of “reliability”).

In one embodiment of the invention, the regulatory or non-regulatory nature of the meteorological information displayed can be signalled to the pilot (for example the regulatory meteorology can be framed in red whereas the informative meteorology would not be framed).

In a development, the method further comprises the step consisting in receiving an indication of the qualification of at least one datum or source of meteorological data of non-regulatory type in a meteorological datum of regulatory type.

In one an embodiment, a communication or feedback loop (with the regulator, an ATC or a certified and/or authorized organization) can make it possible to requalify the meteorological information. For example, the presence of migratory birds alongside a given airport may be “endorsed” by the appropriate regulator.

A computer program product is disclosed, comprising code instructions making it possible to perform the steps of the method when said program is run on a computer.

A system is disclosed comprising means for implementing the steps of the method.

In a development, the system comprises a display screen of an Electronic Flight Bag.

In a development in addition, or instead, the system comprises at least one display screen chosen from a flight screen PFD and/or a navigation screen ND/VD and/or a multifunction screen MFD.

In a development, in addition or instead, the system comprises at least one display of touch screen type.

In a development, in addition or instead, the system comprises augmented reality and/or virtual reality means.

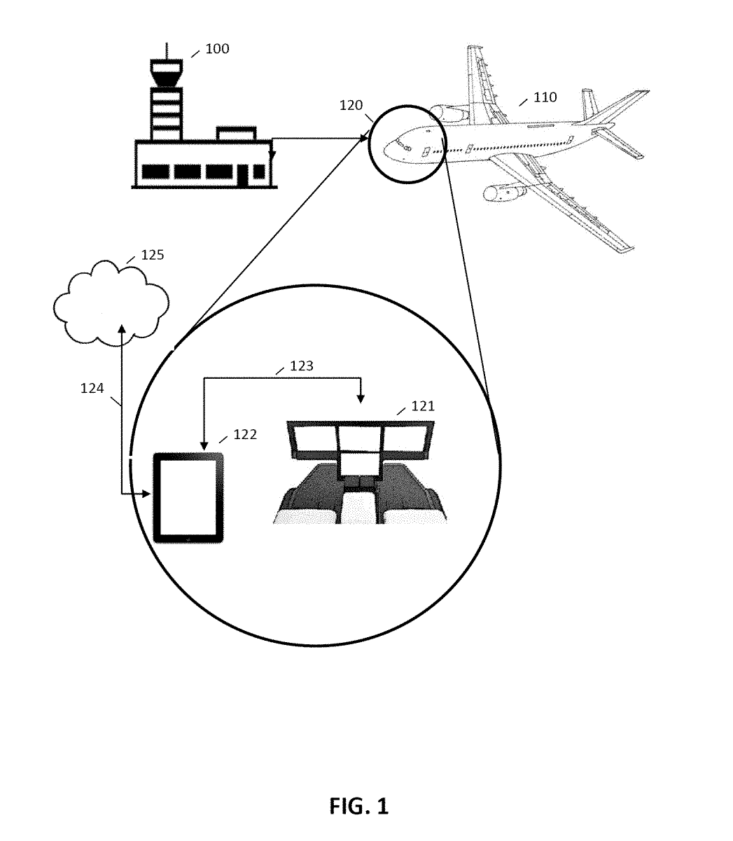

FIG. 1 illustrates the overall technical environment of the invention. Avionics equipment items or airport means 100 (for example a control tower linked with the air traffic control systems) are in communication with an aircraft 110. An aircraft is a transport means capable of moving in the earth's atmosphere. For example, an aircraft can be an aeroplane or a helicopter (or even a drone). The aircraft comprises a piloting cabin or a cockpit 120. In the cockpit, there are piloting equipment items 121 (called avionics equipment items), comprising, for example, one or more onboard computers (computation, memory and data storage means), including an FMS, means for displaying or viewing and inputting data, communication means, and (possibly) haptic feedback means and a taxiing computer. A touch tablet or an EFB 122 can be located onboard, in portable form or incorporated in the cockpit. Said EFB can interact (bilateral communication 123) with the avionics equipment items 121. The EFB can also be in communication 124 with external computer resources, accessible via the network (for example cloud computing 125). In particular, the computations can be performed locally on the EFB or partially or totally in the computation means accessible via the network. The onboard equipment items 121 are generally certified and regulated whereas the EFB 122 and the connected computing means 125 are generally not certified (or are to a lesser extent). This architecture makes it possible to inject flexibility on the side of the EFB 122 while ensuring a controlled security on the embedded avionics 121 side.

Among the onboard equipment items there are different screens. The ND screens (graphic display associated with the FMS) are generally arranged in the primary field of view, “head mean”, whereas the FMDs are positioned “head down”. All of the information entered or computed by the FMS is grouped together on so-called FMD pages. The existing systems make it possible to navigate from page to page, but the size of the screens and the need to not place too much information on a page for its legibility make it impossible to apprehend all of the current and future situation of the flight in summary fashion. The crews of modern aeroplanes in the cockpit generally consist of two people, distributed on either side of the cockpit: a “pilot” side and a “co-pilot” side. Business aeroplanes sometimes have only a pilot, and certain older aeroplanes or military transport planes have a crew of three people. Everyone views on his or her HMI the pages that are of interest to him or her. Several out of the hundred possible are generally displayed permanently during the execution of the mission: the “flight plan” page first of all which contains the route information followed by the aeroplane (list of the next waypoints with their associated predictions in terms of distance, time, altitude, velocity, fuel, wind). The route is divided into segments, legs and procedures, which are themselves made up of points and comprises a “performance” page which contains the parameters useful for guiding the aeroplane over the short term (velocity to be followed, altitude ceilings, next changes of altitude). There are also a multitude of other pages available onboard (the lateral and vertical revision pages, the information pages, pages specific to certain aircraft), or generally a hundred or so pages.

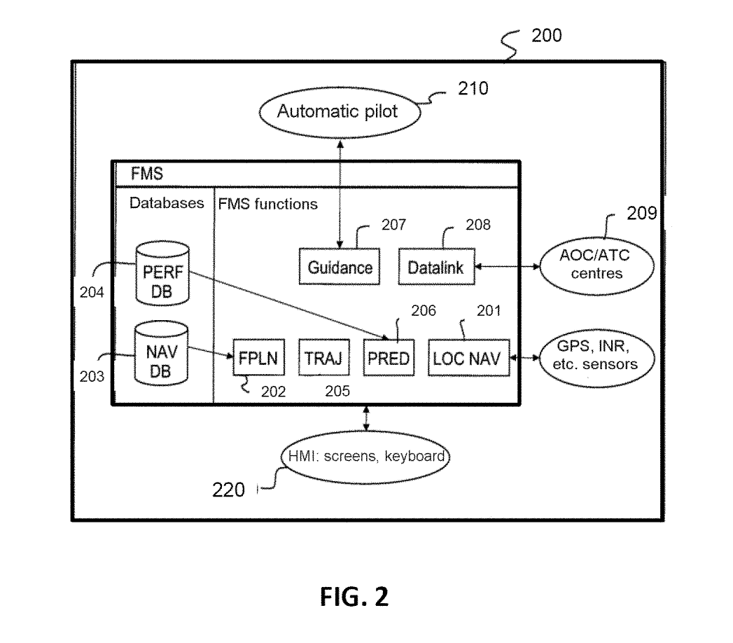

FIG. 2 schematically illustrates the structure and the functions of a flight management system of known FMS type. A system of FMS type 200 arranged in the cockpit 120 and the avionics means 121 has a human-machine interface 220 comprising input means, for example formed by a keyboard, and display means, for example formed by a display screen, or else simply a touch display screen, and at least the following functions:
Navigation (LOCNAV) 201, to perform the optimal location of the aircraft as a function of the geolocation means such as the GNSS satellite geolocation (e.g. GPS, GALILEO, GLONASS, etc.), the VHF radio navigation beacons, the inertial units. This module communicates with the above-mentioned geolocation devices;
Flight plan (FPLN) 202, for inputting geographical elements forming the “skeleton” of the route to be followed, such as the points imposed by the departure and arrival procedures, the waypoints, the air corridors, commonly called “airways”. An FMS generally hosts several flight plans (the so-called “active” flight plan over which the aeroplane is guided, the “temporary” flight plan making it possible to make modifications without activating the guidance over this flight plan and the “inactive” working flight plans (called “secondary”).
Navigation database (NAVDB) 203, for constructing geographic routes and procedures from data included in the bases relating to the points, beacons, interception or altitude legs, etc.;
Performance database, (PERFDB) 204, containing the aerodynamic and engine parameters of the aircraft;
Lateral trajectory (TRAJ) 205, for constructing a continuous trajectory from the points of the flight plan, observing the performance levels of the aircraft and the confinement constraints (RNAV for Area Navigation or RNP for Required Navigation Performance);
Predictions (PRED) 206, for constructing an optimized vertical profile on the lateral and vertical trajectory and giving the estimations of distance, time, altitude, velocity, fuel and wind notably on each point, at each change of piloting parameter and at destination, which will be displayed to the crew;
Guidance (GUID) 207, for guiding, in the lateral and vertical planes, the aircraft on its three-dimensional trajectory, while optimizing its velocity, using information computed by the Predictions function 206. In an aircraft equipped with an automatic piloting device 210, the latter can exchange information with the guidance module 207;
Digital datalink (DATALINK) 208 for exchanging flight information between the flight plan/prediction functions and the control centres or other aircrafts 209;
one or more HMI screens 220.

All of the information entered or computed by the FMS is grouped together on display screens (FMD, NTD and PFD pages, HUD or similar). In airline aeroplanes of Airbus A320 or A380 type, the trajectory of the FMS is displayed as head mean, on a display screen called Navigation Display (ND). The “Navigation display” offers a geographic view of the situation of the aircraft, with the display of a cartographic background (the exact nature, appearance and content of which can vary), sometimes with the flight plan of the aeroplane, the characteristic points of the mission (equal time point, end of climb, start of descent, etc.), the surrounding traffic, the weather in its various aspects such as the areas of rain and storms, icy conditions, etc., generally originating from the embedded meteorological radar (e.g. echoes of reflectivity which make it possible to detect rainy or stormy areas). On the aeroplanes of the Airbus A320, A330, A340, Boeing B737/747 generation, there is no interactivity with the display screen of the flight plan. The construction of the flight plan is done from an alphanumeric keyboard on a so-called MCDU (Multi-Purpose Control Display) interface. The flight plan is constructed by inputting the list of the “waypoints” represented in tubular form. It is possible to input a certain number of information items on these “waypoints”, via the keyboard, such as the constraints, (velocity, altitude) that the aeroplane must observe in passing the waypoints. This solution presents a number of defects. It does not make it possible to deform the trajectory directly, it has to be done by a successive input of “waypoints”, either existing in the navigation databases (NAVDB standardized onboard in the AEEC ARINC 424 format), or created by the crew via its MCDU (by inputting coordinates for example). This method is tedious and inaccurate given the size of the current display screens and their resolution. For each modification (for example a deformation of the trajectory to avoid random dangerous weather, which is moving), it may be necessary to re-input a succession of waypoints outside of the area concerned.

From the flight plan defined by the pilot (list of “waypoints”), the lateral trajectory is computed as a function of the geometry between the waypoints (commonly called leg) and/or the altitude and velocity conditions (which are used to compute the turn radius). On this lateral trajectory, the FMS optimizes a vertical trajectory (in terms of altitude and velocity), involving any altitude, velocity, time constraints. All of the information entered or computed by the FMS is grouped together on display screens (MFD pages, NTD and PFD displays, HUD or similar). The HMI part 220 of FIG. 2 therefore comprises a) the HMI component of the FMS which structures the data for sending to the display screens (called CDS for Cockpit Display system) and b) the CDS itself, representing the screen and its graphic driver software, which handles the display of the drawing of the trajectory and which also comprises the computer drivers that make it possible to identify the movements of the finger (in the case of a touch interface) or of the pointing device.

All of the information entered or computed by the FMS is grouped together on “pages” (graphically displayed on one or more screens of the FMS). The existing systems (called “glass cockpits”) make it possible to navigate from page to page, but the size of the screens and the need to not overload the pages (in order to preserve their legibility) do not make it possible to apprehend the current and future situation of the flight in summary fashion. Thus, the search for a particular element of the flight plan can take the pilot a long time, above all if he or she has to navigate in numerous pages (long flight plan). In effect, the different FMS and screen technology currently used make it possible to display only between 6 and 20 lines and between 4 and 6 columns.

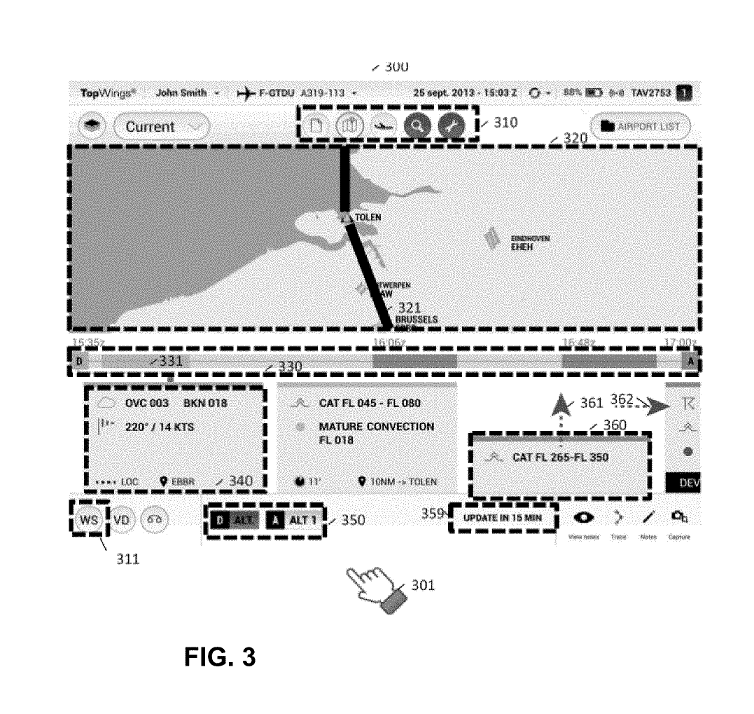

FIG. 3 shows an example of a human-machine interface according to the invention for displaying information of meteorological nature.

Different embodiments of the method according to the invention are described hereinbelow.

In one embodiment, for example by using a tablet of EFB type, a graphical interface 300 is displayed to the pilot or a member of the crew. The graphical interface comprises navigation options (e.g. a plurality of selectable symbols). In one embodiment, the display of the meteorological data is permitted by means of selections made on independent variables that are the time and altitude (symbols 350 making it possible to choose the flight altitudes for filtering the meteorological information). In particular, the interface can offer access to the data concerning the meteorological conditions existing in different airports (e.g. diversion airport, airport of arrival, etc.).

The graphical interface can display a cartographic background 320 (aerial map), notably showing the flight plan 321. In an embodiment, the graphical interface comprises a graphic representation of the flight plan in two dimensions on which are represented the different meteorological events that the aircraft will encounter during its flight plan.

The graphical interface can display a “ribbon” or “strip” 330, representing the meteorological events encountered by the aircraft along the flight plan (for example the meteorological event 331). In other words, the flight can be represented by a horizontal line in which the meteorological events are represented. This line can indicate the departure airport and the next meteorological phenomena.

A meteorological event can be associated with a descriptive display area which provides qualitative and/or quantitative details on said event or related thereto (place, intensity, altitude, validity time interval, probability, metadata, data sources, graphics symbol, etc.). For example, the meteorological event 331 is associated with the descriptive display area 340.

In one embodiment, the method according to the invention comprises a “meteorological summary” mode (e.g. selectable icon WS 311).

Each meteorological event is associated with a date or with time information and/or is associated with a position in space (2D or 3D), that is to say with an instant in time at which the meteorological event should take place and/or a time band during which the meteorological event is considered valid). In an optional embodiment, each meteorological event is associated with a score (aggregate encoding a severity level in terms of potential consequences on safety, associated probabilities, etc.).

Optionally, colour codes can be used to indicate the severity of each meteorological event.

Dynamically, the descriptive display areas are updated, as and when the corresponding data are received and the meteorological databases are refreshed. The meteorological data are received by the aircraft by dedicated satellite links, at fixed or variable intervals . . .

An optional indicator 359 indicates to the pilot when the next update will be (in the example, the refreshing of the data is planned every 15 minutes).

In one embodiment, upon an update, the insertion and/or the deletion and/or the modification of a descriptive display area can be notified graphically. The insertion of a descriptive display area associated with a meteorological event 360 will for example be able to be signalled by the right-shifting of a descriptive display area 362 and a sliding insertion 361 of the new descriptive display area 360. The deletion of a descriptive display area (e.g. disappearance of the corresponding meteorological event, obsolescence of the data, etc.) will also be able to illustrated graphically (e.g. grey level colouring, blinking, fade-out, etc.). The modification of a descriptive display area will similarly be able to be signalled graphically (e.g. coloured outlines, dedicated graphic symbol, display of dimension “new”, blinking, etc.). Other types of graphic animations are possible (colours, shapes, textures, sounds, vibrations, etc.).

Advantageously, the graphic indications (or more generally indications of haptic nature) associated with the changes of data in the flow of meteorological data make it possible to draw the attention of the pilot to the most recent data. The display modes described previously give the pilot an overview of the meteorology: the access to the data is simplified “superficially” (extended vision in time) and also “depth wise” (levels of details accessible). The decision-making by the pilot is improved. The safety of the flight is also improved, the meteorological data being critical information.

In an embodiment of the invention, a meteorological summary mode 311 keeps the pilot involved in the management of the meteorological factors. In an embodiment, after selection or activation of the graphic icon, one or more predefined logic rules determine major meteorological events that the aircraft will encounter along the flight plan. The predefined logic rules notably comprise the use of filtering rules and predefined thresholds.

In an embodiment, the method according to the invention determines the current flight plan and/or an approximate flight plan and creates a list of meteorological events that the aircraft will encounter over the time (i.e. the time that it moves in space). Since the meteorological conditions concerning the aircraft are continually updated, the lists of events are iteratively defined. The flight plan can also be updated, which in turn refreshes the data. Consequently, the meteorological summary mode 311 is also continually updated. The more detailed the flight plan, the more accurate, relevant and useful to the pilot can be the associated list of meteorological events.

In particular, the taking into account of the meteorological data is important in flight plan revisions. In the preparation for the flight on the ground, the pilot can have an initial idea of the most difficult parts of the flight. During the flight, the updating of the meteorological data enables the pilot to make his or her decisions in an informed manner.

In an embodiment, the descriptive display areas of the meteorological events are structured in a standardized manner in order to be able to be read quickly by the pilot. The display areas can be coloured in different ways (e.g. background, etc.) so as to encode the information. The descriptive display areas can notably provide information concerning the time it takes for the aircraft to pass through the meteorological event (as a function of its velocity), indications on the start time and/or the end time of the passage through the meteorological event concerned, associated spatial indications (location, movement of the meteorological disturbances), etc.

In an embodiment of the invention, the descriptive display areas can also comprise advice and suggestions for the pilot. The method according to the invention can in fact determine and suggest revisions of the flight plan in a way that is quantified as a function of the meteorological data (and also as a function of other parameters such as fuel consumption, estimated time of arrival, etc.). The advice or recommendations or suggestions can notably comprise information concerning de-icing, fuel reserve management, etc.

In an embodiment, a descriptive display area comprises a) a time band indicating the start and end in time of the phenomenon, along the flight plan, according to the velocity of the aeroplane. In the case of “discrete” phenomena, the band between the first occurrence and the last occurrence is considered; b) the highest severity (colour code) encountered in the time band considered; c) a location indicated textually on the basis of the flight plan waypoints; d) the main features of this phenomenon (significance, force, size, altitudes, etc.) and e) any recommendations for the pilot.

For example, in the case of severe meteorological conditions, an avoidance or a fork will be able to be suggested to the pilot. In the case where several meteorological phenomena would be simultaneous, a filtering rule can consist in ranking the meteorological phenomena by descending order of severity (or according to a pre-established order).

In an embodiment of the invention, the pilot can consult meteorological display areas at different moments over time, and notably compare the trends of the meteorological events (“before, after”).

In an embodiment of the invention, the pilot can select a meteorological display area background from several, display the current flight plan, select and display one or more types of meteorological information.

In an embodiment of the invention, the pilot can consult maps of alternate airports. The summary information according to the invention may not systematically display these airports, but they can generally remain accessible at all times.

In an embodiment of the invention, the pilot can select one or more types of meteorological events in order to obtain the graphic representation thereof (for example, the meteorological information will be displayed on the cartographic background or on a horizontal line or bar representing the flight plan).

In an embodiment of the invention, the pilot can select airports of departure and of arrival to display a corresponding map.

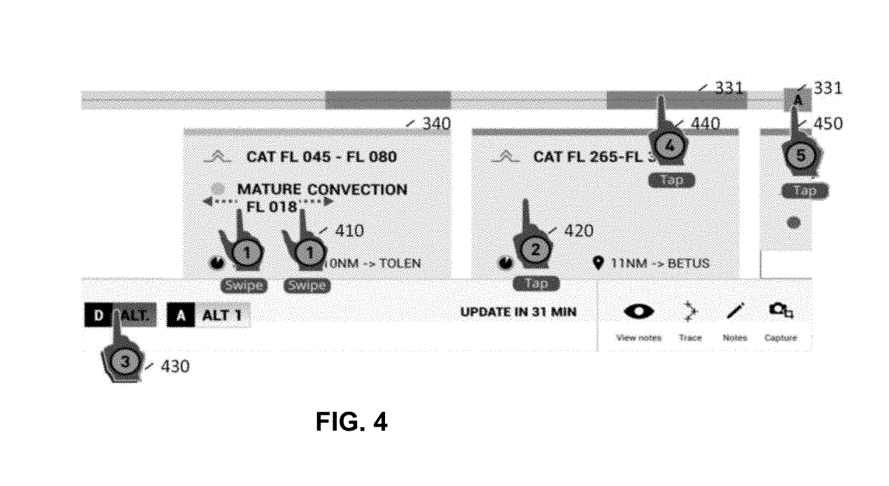

FIG. 4 illustrates examples of interaction of the pilot with the human-machine interface according to the invention.

In an embodiment of the invention, the updates are automatic and the graphic animations of addition, deletion and modification of the meteorological data proceed without intervention from the pilot.

In an embodiment of the invention, the pilot can interact with the interface actively. In an embodiment of the invention, the graphical interface is of touch type. The pilot can move (or drag) 410 a descriptive display area to the left or to the right. By selecting a descriptive display area 420, the cartographic background can be re-centred on the flight plan point considered and/or the associated flight plan portion 331 can be selected in the strip or ribbon. By selecting the graphic symbol “ALT” 430, the pilot can also access the descriptive display areas associated with the meteorological information concerning the alternate airports (generally, these descriptive display areas are not displayed by default since they do not relate to the current flight plan). The symbols “A” (for “Arrival”) or “D” (for “Departure”) can be selected by the pilot; if appropriate, the associated descriptive display area is displayed on the screen.

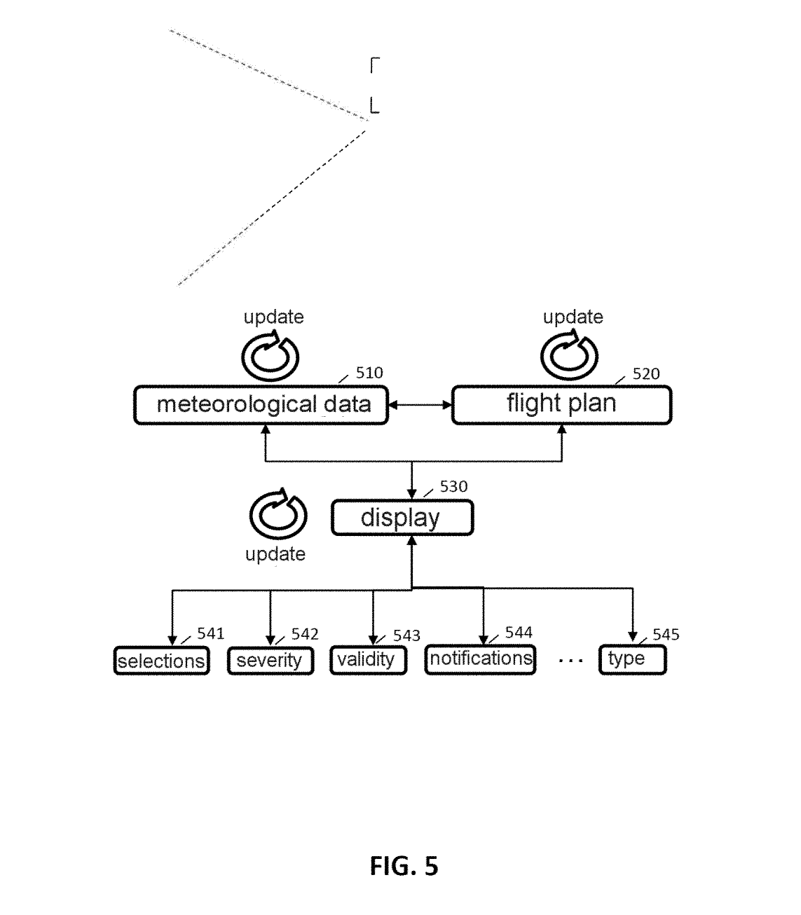

FIG. 5 shows examples of steps of the method according to the invention.

A cartographic background and meteorological data 510 are received, in association with a first flight plan (for example with the current flight plane 520, which is updated according to the various revisions). The display 530 according to the method is then updated, based on the updating of the meteorological data 510 and/or the refreshed flight plan 520. Predefined selection criteria can make it possible to display only the meteorological data relevant to the flight plan considered. The adjustment of the display in itself can be performed in various ways notably by the taking into account and/or the restoration of selections 541 (by the pilot and/or third party programs), by the taking into account and/or the restoration of the severity of one or more meteorological events relevant to the current flight plan, by the taking into account and/or the restoration of data relating to the validity in time of the data (e.g. obsolescence, display of the delay up to the next updating of the data, etc.), by the emission of alerts and/or of selectable notifications, by the management of data other than meteorological data of regulatory type, etc.

In an embodiment of the invention, the different meteorological events can be associated with reliability measurements (e.g. indices or scores or other quantifications of reliability) and/or probabilities of occurrence (e.g. statistical confidence intervals, etc.). Such metadata can make it possible to modulate or adapt or modify the display of the meteorological information (the pilot can him or herself proceed to contextualize the actions of the information displayed; the logic rules application can make selections of the meteorological events to be displayed and/or adapt the ways in which such information is graphically displayed).

In an embodiment of the invention, the meteorological data and the metadata can be taken into account by the flight management system FMS (an FMS that is certified but also by an FMS that is not certified interacting with a certified avionics core) in order to supply the pilot with feedback concerning, if necessary, one or more modifications of the flight plan.

According to a variant embodiment, the method according to the invention comprises a step consisting in determining the impact on trajectory (e.g. a quantified spatial difference) of a modification of the meteorological data received by the aircraft. In other words, the refreshing of the meteorological data can be “looped” (for example in the background, that is to say in a way not directly visible to the pilot) with the computation of the trajectories of the aircraft, as determined by the certified and/or regulated system of the FMS, or by the EFB system connected to the avionics data. For example, if the occurrence of a particularly violent stormy phenomenon is detected along the flight plan of the aircraft, the method according to the invention can “anticipate” the changes downstream, that is to say determine a modification (necessary or for safety) of the flight plan making it possible to circumvent the dangerous phenomenon (for example at a predefined safe distance). Background checks therefore make it possible to continuously validate the current flight plan (and/or the “Alternate” flight plan).

In a particular embodiment of the invention, the occurrence or the existence of a meteorological phenomenon or event that is dangerous or severe, in as much as this phenomenon necessitates a modification of the flight plan (as determined and validated by the flight management system), can be notified to the pilot graphically, in order to draw his or her attention.

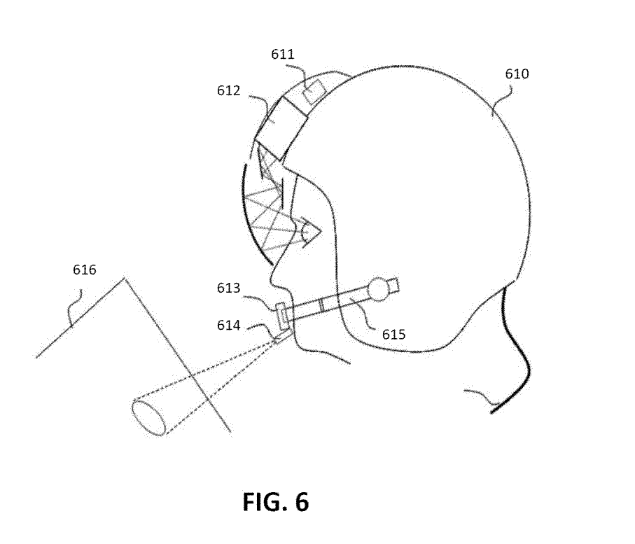

FIG. 6 illustrates variant embodiments of the human-machine interface according to the invention.

Different human-machine interfaces HMI can be set up to implement the method according to the invention. In addition—or instead—screens of the onboard FMS and/or EFB computer, additional HMI means can be used. Generally, the FMS avionics systems (which are systems certified by the air regulator and which can exhibit certain limitations in terms of display and/or ergonomy) can advantageously be complemented by non-avionics means, in particular advanced HMIs.

The representation of at least a part of the flight of the aircraft can be produced in two dimensions (e.g. display screen) but also in three dimensions (e.g. virtual reality or 3D display on screen). In 3D embodiments, the descriptive display areas can take the form of volumes that can be selected (by various means, e.g. by virtual reality interfaces, by glove, by trackball or by other devices), for example a range within a 3D office.

The selection of a given volume can for example trigger a 2D or 3D graphic visualization of the meteorological event concerned (e.g. cloud masses, velocity vector field, etc.). Optionally, the pilot can simulate passing through the meteorological event.

The three-dimensional display can complement the two-dimensional display within the cockpit (e.g. semi-transparent virtual reality headset, augmented reality headset, etc.). If necessary, various forms of representation of the flight are possible, the additional depth dimension being able to be allocated to a time dimension (e.g. flight duration) and/or space dimension (e.g. distance between the different waypoints, physical representation of the trajectory of the aircraft in space, etc.).

The same variants or variants similar to the 2D case can be implemented: management of alert thresholds, of the severity of the meteorological events, highlighting of the events during the flight, etc.

In particular, the human-machine interfaces can make use of virtual and/or augmented reality headsets. FIG. 6 shows an opaque virtual reality headset 610 (or a semi-transparent augmented reality headset or a headset with configurable transparency) worn by the pilot. The individual display headset 610 can be a virtual reality (VR) headset, or an augmented reality (AR) headset or a head-up display, etc. The headset can therefore be a “head-mounted display”, a “wearable computer”, “glasses” or a video headset. The headset can comprise computation and communication means 611, projection means 612, audio acquisition means 613 and video projection and/or video acquisition means 614. In this way, the pilot can—for example by means of voice commands—visualize the flight plan in three dimensions (3D). The information displayed in the headset 610 can be entirely virtual (displayed in the individual headset), entirely real (for example projected onto the flat surfaces available in the real environment of the cockpit) or a combination of the two (partly a virtual display superimposed on or merged with the reality and partly a real display via projectors).

Reproduction of information can notably be performed in a multimodal manner (e.g. haptic feedback, visual and/or auditory and/or tactile and/or vibratory reproduction).

The various steps of the method can be implemented wholly or partly on the FMS and/or on one or more EFBs. In a particular embodiment, all of the information is displayed on the screens of just the FMS. In another embodiment, the information associated with the steps of the method is displayed on just the embedded EFBs. Finally, in another embodiment, the screens of the FMS and of an EFB can be used jointly, for example by “distributing” the information over the different screens of the different devices. A spatial distribution of the information performed in an appropriate manner can contribute to reducing the cognitive load of the pilot and consequently improve the decision-making and increase the flight safety. The invention can also be implemented on or for different display screens, notably the flight bags EFB.

In a development, the system comprises augmented reality and/or virtual reality means. The AR means comprise in particular systems of HUD (“Head Up Display”) type and the VR means comprise in particular systems of EVS (“Enhanced Vision System”) or SVS (“Synthetic Vision System”) type. The display means can comprise, in addition to the screens of the FMS, an opaque virtual reality headset and/or a semi-transparent augmented reality headset or a headset with configurable transparency, projectors (pico-projectors for example, or video projectors for projecting the simulation scenes) or even a combination of such devices. The headset can therefore be a “head-mounted display”, a “wearable computer”, “glasses”, a video headset, etc. The information displayed can be entirely virtual (displayed in the individual headset), entirely real (for example projected onto the flat surfaces available in the real environment of the cockpit) or a combination of the two (partly a virtual display superimposed on or merged with the reality and partly a real display via projectors).

The visual information can be distributed or allocated or projected or masked as a function of the immersive visual context of the pilot. This “distribution” can lead to the environment of the pilot being considered in an opportunistic manner by considering all the surfaces available so as to add (superimpose, overlay) virtual information, chosen appropriately in their nature (what to display), temporal aspect (when to display, at what frequency) and placement (priority of the displays, stability of the placements, etc.). At one extreme all of the placements used little or faintly in the environment of the user can be exploited to increase the density of the display of information. Even more, by projection of image masks superimposed on the real objects, the display can “erase” one or more control instruments present physically in the cockpit (joysticks, knobs, actuators), the geometry of which is known and stable to further increase the surfaces that can be addressed. The real environment of the cockpit can therefore be transformed into as many “potential” screens, even into a single unified screen.

The display can be “distributed” within the cockpit: the various screens present in the cockpit, depending on whether they are accessible or not, can be made to contribute in allocating the information which has to be displayed. Moreover, augmented and/or virtual reality means can increase the display surfaces. The augmentation of the available display surface does not render the control of the display density permitted by the invention null and void. On the contrary, the (contextual) reconfiguration of the display agglomerating this increase in the addressable display surface and the control of the visual density (e.g. contextual concentration or density increase) make it possible to significantly enhance the human-machine interaction.

In an embodiment, the reconfiguration of the screen according to the invention can be “disengaged”, i.e. the pilot can decide to cancel or deactivate all the modifications of the current display to revert quickly to the “nominal” display, i.e. native mode without the display modifications. The reconfiguration mode can for example be exited by voice command (passphrase) or via an actuator (deactivation button). Different events can trigger this precipitated exit from the graphic reconfigurations in progress (for example “sequencing” of a waypoint, a change of flight phase, the detection of a major anomaly such as an engine failure, a depressurization, etc.).

In a development, the system comprises exclusively interface means of touch type. In a particular embodiment of the invention, the cockpit is all touch, i.e. exclusively made up of HMI interfaces of touch type. The methods and systems according to the invention in fact allow for “all touch” embodiments, that is to say according to a human-machine interaction environment entirely made up of touch screens, with no tangible actuator but, advantageously, entirely reconfigurable.

In a development, the system further comprises means for requiring images of the cockpit (e.g. interpretation or reinjection of data by OCR and/or image recognition—by “scraping”—, camera mounted on a headset worn by the pilot or camera fixed at the rear of the cockpit) and/or a gaze tracking device.

The present invention can be implemented from hardware and/or software elements. It can be available as computer program product on a computer-readable medium. The medium can be electronic, magnetic, optical or electromagnetic. Some computing means or resources can be distributed (“cloud computing”).

1. A method implemented by a computer for managing meteorological data for managing the flight of an aircraft, comprising the steps of:
receiving a cartographic background from several predefined cartographic backgrounds;
receiving meteorological data associated with the flight plan of the aircraft;
selecting one or more meteorological events from said meteorological data;
displaying one or more graphic representations associated with the meteorological events selected on a horizontal or vertical strip representing the flight plan of the aircraft;
based on the updating of the meteorological data, refreshing the display of the meteorological data selected and associated with the flight plan of the aircraft.

2. The method according to claim 1, further comprising a step of receiving a revision of the flight plan of the aircraft and a step of adapting the steps of selecting and displaying the selected meteorological events.

3. The method according to claim 1, the step of refreshing the display of the meteorological data comprising one or more steps chosen from the steps comprising a step of adding the graphic representation of a meteorological event, a step of deleting the graphic representation of a meteorological event and a step of modifying the graphic representation of a meteorological event.

4. The method according to claim 1, the graphic representation of a meteorological event being a descriptive area, wherein at least a part of the graphic form and/or of the colour and/or of the texture is determined as a function of the degree of severity of the associated meteorological event.

5. The method according to claim 1, the graphic representations of the meteorological events being arranged according to predefined display priorities.

6. The method according to claim 1, at least one meteorological event being associated with a one-off time of occurrence and/or a validity time interval.

7. The method according to claim 1, further comprising the step of displaying the time delay before the next expected update of the meteorological data.

8. The method according to claim 1, further comprising a step of determining a flight plan modification or revision or a flight setpoint as a function of at least one modification of meteorological data and a step of displaying said modification or revision or setpoint to the pilot.

9. The method according to claim 1, further comprising a step of determining the modification of the flight plan of the aircraft necessary to fly around a meteorological event determined as severe and a step of displaying an alert if said modification of the flight plan exceeds a predefined threshold.

10. The method according to claim 1, further comprising a step of determining the existence of a meteorological event associated with a severity level in excess of a predefined threshold and a step of graphically displaying a selectable visual notification indicating the existence of said meteorological event.

11. The method according to claim 1, the meteorological data being meteorological data of non-regulatory type.

12. The method according to claim 1, further comprising the step of receiving indication of the qualification of at least one datum or source of meteorological data of non-regulatory type and a meteorological datum of regulatory type.

13. A computer program product, comprising code instructions making it possible to perform the steps of the method according to claim 1, when said program is run on a computer.

14. A system comprising display means for implementing the steps of the method according to claim 1.

15. The system according to claim 14, comprising a display screen of an Electronic Flight Bag.

16. The system according to claim 14, comprising at least one display screen chosen from a PFD flight screen and/or an ND/VD navigation screen and/or an MFD multifunction screen.

17. The system according to claim 14, comprising at least one screen of touch screen type.

18. The system according to claim 14, comprising augmented reality and/or virtual reality means.
